(19) United States
(12) Patent Application Publication
(10) Pub. No.: US 2014/0046621 A1
(43) Pub. Date: Feb. 13, 2014

(54) ELECTRONIC DEVICE FOR SENSING AND RECORDING DYNAMIC STATE TO ENABLE PERFORMANCE DEVICE TO PRESENT CORRESPONDING PERFORMANCE

(71) Applicant: Ming-Tse YANG, Taipei City (TW)

(72) Inventor: Ming-Tse YANG, Taipei City (TW)

(21) Appl. No.: 13/618,740

(22) Filed: Sep. 14, 2012

(30) Foreign Application Priority Data
Aug. 13, 2012 (TW) 101215581

(51) Int. Cl. G06F 15/00

(52) U.S. Cl. 702/141; 702/182

(57) ABSTRACT

An electronic device for sensing and recording a dynamic state to enable a performance device to present a corresponding performance is provided. The electronic device includes a body, a processing unit, a sensing module, and a storage module. The sensing module detects a dynamic state of the body and sends a detected signal to the processing unit. The processing unit carries out a signal recording action for recording the signal detected by the sensing module and storing the signal in the storage module. The processing unit processes or judges the signal. A performance device performs a performance corresponding to the dynamic state of the body.

### BACKGROUND OF THE INVENTION

1. Technical Field

The present invention relates to electronic devices for sensing a dynamic state, and more particularly, to an electronic device for sensing and recording a dynamic state to enable a performance device to present a corresponding performance.

2. Description of Related Art

U.S. Pat. No. 7,695,341 discloses a toy cat. U.S. Pat. No. 6,585,556 discloses a toy bear. U.S. Pat. No. 6,053,797 discloses a doll. The aforesaid toys are capable of interacting with a user. Take U.S. Pat. No. 7,695,341 as an example, the toy cat turns its head to the left, as soon as a rightward sensor on the head of the toy cat senses a signal. Hence, the aforesaid interaction mode disclosed in U.S. Pat. No. 7,695,341 is monotonous, because it involves giving a fixed response according to a sensing result.

Also, take a shaking dynamic state as an example, for instance, there is a discernible difference in taste between hand-shaken iced coffee or hand-shaken bubble tea served by inexperienced vendors and that served by experienced vendors. The difference in taste depends on the magnitude, direction, frequency, and trace of the shake. The experienced vendors excel the inexperienced vendors in giving good taste to hand-shaken iced coffee or hand-shaken bubble tea. Hence, if the experienced vendors' shaking skills are recorded and analyzed, it will be feasible to ensure consistency in the taste of hand-shaken iced coffee or hand-shaken bubble tea every time it is served.

### SUMMARY OF THE INVENTION

It is an objective of the present invention to provide an electronic device for sensing and recording a dynamic state to enable a performance device to present a corresponding performance, wherein the electronic device senses and records a dynamic state of a body to thereby enable a performance device to perform the dynamic state.

In order to achieve the above and other objectives, the present invention provides an electronic device for sensing and recording a dynamic state to enable a performance device to present a corresponding performance. The electronic device comprises: a body; a processing unit disposed in the body; a sensing module disposed in the body and electrically connected to the processing unit such that, once the body enters a dynamic state, the sensing module will detect the dynamic state of the body and send a detected signal to the processing unit; and a storage module disposed in the body and electrically connected to the processing unit, wherein the electronic device is characterized in that: the processing unit carries out consecutively the following actions: a signal recording action for recording a signal detected by the sensing module and storing the detected signal in the storage module; and a signal converting action for converting the detected signal stored in the storage module into an output data, wherein the output data relates to a dynamic trace of the body, wherein the processing unit sends the output data to a performance device, and an object performs the same dynamic trace as the body does according to the output data by means of the performance device. Accordingly, the electronic device senses and records a dynamic state of a body, so as for a performance device to perform the dynamic state.

Preferably, the sensing module comprises at least a trace sensor.

Preferably, the at least a trace sensor is a proximity sensor, acceleration sensor, gyroscope, G sensor, or geomagnetic sensor. The at least a trace sensor is one of a plurality of proximity sensors, acceleration sensors, gyroscopes, G sensors, and geomagnetic sensors, or a combination thereof.

Preferably, the performance device is a movable platform capable of moving and moving to and fro in at least one of four directions, namely the directions of x-axis, y-axis, z-axis, and φ-axis (rotation axis), wherein the object is removably fixed to the movable platform.

Preferably, the movable platform has a clamp for clamping the object.

Preferably, the processing unit is connected to the performance device by wired connection or wireless connection.

Another objective of the present invention is to provide an electronic device for sensing and recording a dynamic state to enable a performance device to present a corresponding performance, such that the electronic device senses and records a dynamic state of a body, so as for a performance device to present a corresponding performance.

In order to achieve the above and other objectives, the present invention provides an electronic device for sensing and recording a dynamic state to enable a performance device to present a corresponding performance. The electronic device comprises: a body; a processing unit disposed in the body; a sensing module disposed in the body and electrically connected to the processing unit such that, once the body enters a dynamic state, the sensing module will detect the dynamic state of the body and send a detected signal to the processing unit; and a storage module disposed in the body and electrically connected to the processing unit, wherein the electronic device is characterized in that: the electronic device further comprises a performance device electrically connected to the processing unit; the processing unit carries out a signal recording action for recording a signal detected by the sensing module and storing the detected signal in the storage module; the processing unit determines whether the signal stored in the storage module meets a threshold criterion and controls the performance device to carry out a performance action when the determination is affirmative. Accordingly, the electronic device senses and records a dynamic state of a body, so as for a performance device to present a corresponding performance.

Preferably, the performance device is a loudspeaker, light source, vibration source, or marker, whereas the performance action involves, correspondingly, making a sound, emitting light, generating vibration, or producing a mark.

Preferably, the signal stored in the storage module comprises at least one of trace, extent of variation in gravity, direction, and rotation-related data, wherein the threshold criterion is a trace length, extent of variation in gravity, number of direction changes, or whether a rotation angle is larger or smaller than a threshold value.

### BRIEF DESCRIPTION OF THE DRAWINGS

Technical features of the present invention are hereunder illustrated with preferred embodiments in conjunction with the accompanying drawings, in which:

FIG. 1 is a structural block diagram of the first preferred embodiment of the present invention;

FIG. 2 is a structural schematic view of the first preferred embodiment of the present invention; and

FIG. 3 is a structural block diagram of the second preferred embodiment of the present invention.

### DETAILED DESCRIPTION OF THE EMBODIMENTS OF THE INVENTION

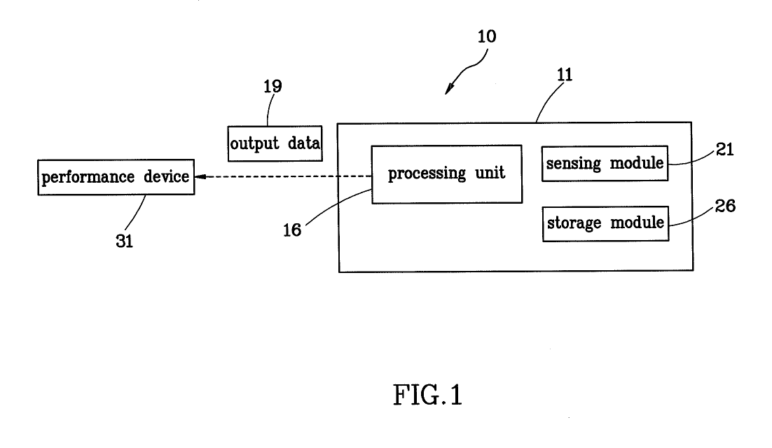

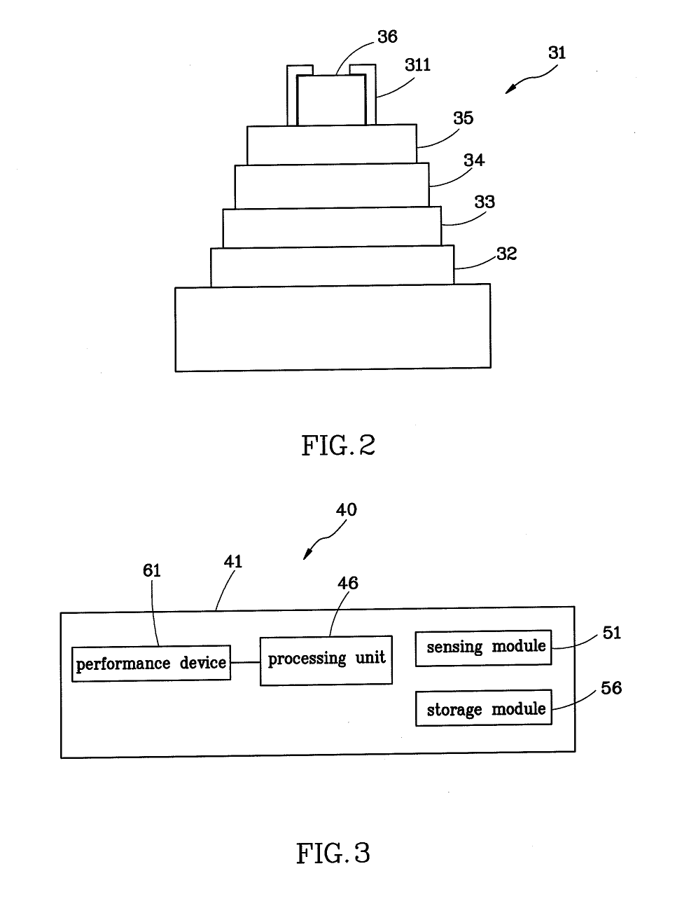

Referring to FIG. 1 and FIG. 2, the present invention provides in the first preferred embodiment thereof an electronic device 10 for sensing and recording a dynamic state to enable a performance device to present a corresponding performance. The electronic device 10 essentially comprises a body 11, a processing unit 16, a sensing module 21, and a storage module 26.

In practice, the body can be a casing or a frame. The body 11 in the first preferred embodiment of the present invention is a casing.

The processing unit 16 is disposed at the body 11. In the first preferred embodiment of the present invention, the processing unit 16 is disposed in the body 11.

The sensing module 21 is disposed in the body 11 and electrically connected to the processing unit 16. Once the body 11 enters a dynamic state, the sensing module 21 will detect the dynamic state of the body 11 and send a detected signal to the processing unit 16. In this embodiment, the sensing module 21 comprises a trace sensor exemplified by a proximity sensor, acceleration sensor, gyroscope, G sensor, or geomagnetic sensor. However, what is comprehensible is that the sensing module 21 can also comprise a plurality of trace sensors (such as two trace sensors) exemplified by proximity sensors, acceleration sensors, gyroscopes, G sensors, geomagnetic sensors, or a combination thereof.

The storage module 26 is disposed in the body 11 and electrically connected to the processing unit 16.

The processing unit 16 carries out a signal recording action and a signal converting action in sequence, as described below.

The signal recording action involves recording a signal detected by the sensing module 21 and storing the detected signal in the storage module 26.

The signal converting action involves converting the detected signal stored in the storage module 26 into an output data 19, wherein the output data 19 relates to a dynamic trace of the body 11.

The processing unit 16 sends the output data 19 to a performance device 31. In practice, the processing unit 16 is electrically connected to the performance device 31 by wired connection or wireless connection. In this regard, this embodiment is exemplified by wireless connection. Referring to FIG. 1, the dashed line indicates wireless connection. With the performance device 31, an object 36 performs the same dynamic trace as the body 11 does according to the output data 19. In this embodiment, the performance device 31 is a movable platform capable of moving and moving to and fro in at least one of four directions, namely the directions of x-axis, y-axis, z-axis, and φ-axis (rotation axis). Referring to FIG. 2, this embodiment is exemplified by all the aforesaid four directions and thus an x-axis platform 32, a y-axis platform 33, a z-axis platform 34, and a φ-axis platform 35, wherein the object 36 is removably fixed to the movable platform. To this end, the object 36 is clamped and fixed in place by means of a clamp 311 disposed on the performance device 31.

The architecture of the first embodiment is described above. The operation of the first embodiment is described below.

Referring to FIG. 1 and FIG. 2, take hand-shaken bubble tea as an example, during a time period in which a user shakes a shaker and the body 11 together by hand, the processing unit 16 carries out the signal recording action to record data about the trace, magnitude, direction, and rotation angle of the shake thoroughly and stores the data in the storage module 26. Afterward, the processing unit 16 carries out the signal converting action for converting the detected signal stored in the storage module 26 into an output data 19 and sending the output data 19 to the performance device 31. Afterward, another shaker is put on the performance device 31 and fixed thereto with the clamp 311, such that the performance device 31 drives, in accordance with the output data 19, the clamp 311 to cause the other shaker to bring about the same hand-shaking dynamic state as the preceding user does, thereby serving hand-shaken bubble tea of the same taste. The technique of sending a trace data to a mechanical device to thereby reproduce the trace is disclosed in the prior art pertaining to conventional mechanical arms; hence, the technique of effectuating a dynamic state by means of the performance device 31 and in accordance with the output data 19 as illustrated with FIG. 2 according to this embodiment is a feasible technique.

Accordingly, the electronic device 10 in the first embodiment senses and records a dynamic state of the body 11, so as for the performance device 31 to perform the dynamic state and thereby reproduce the dynamic state.

Referring to FIG. 3, the present invention provides in the second preferred embodiment thereof an electronic device 40 for sensing and recording a dynamic state to enable a performance device to present a corresponding performance. The second preferred embodiment differs from the first preferred embodiment in the aspects described hereunder.

The performance device 61 is electrically connected to the processing unit 46. In the second embodiment, the performance device 61 is a loudspeaker, light source, vibration source, marker, or a combination thereof.

The processing unit 46 carries out a signal recording action, but does not carry out the signal converting action described in the first embodiment. The signal recording action involves recording a signal detected by the sensing module 51 and storing the signal in the storage module 56. The signal comprises at least one of, or includes, trace, extent of variation in gravity, direction, and rotation-related data.

The processing unit 46 determines whether the signal stored in the storage module 56 meets a threshold criterion (not shown) and controls the performance device 61 to carry out a performance action when the determination is affirmative. In the second embodiment, the performance action involves making a sound, emitting light, generating vibration, or producing a mark. The threshold criterion is a trace length, extent of variation in gravity, number of direction changes, or whether a rotation angle is larger or smaller than a threshold value.

In the second embodiment, to begin an operation process, the processing unit 46 determines whether the signal meets a threshold criterion. For example, the performance device comprises a combination of five LED lamps and a loudspeaker. To simulate a state where soft drink is being shaken, it is feasible to set the threshold criterion to shaking to and fro 20 times. If the user shakes the body 41 to and fro and repeatedly, the cumulative number of changes of the direction of the motion of the body 41 will increase accordingly. The processing unit 46 controls one of the five LED lamps to light up as soon as the cumulative number of changes of the direction of the motion of the body 41 increases by 4. In doing so, the LED lamps light up one by one, as the cumulative number of changes of the direction of the motion of the body 41 continues to increase. By the time when the cumulative number of changes of the direction of the motion of the body 41 reaches 20, all the five LED lamps have lit up, and the processing unit 46 determines that the threshold criterion is met and thereby controls the performance device 61 to generate a soda can-opening hissing sound. For example, a game, during which players simulate holding an object steadily, requires setting the threshold criterion to a trace length of less than 20 cm. If the displacement of the body 41 held in the user's hands exceeds 20 cm, the processing unit 46 will control the performance device 61 to vibrate. For example, when it comes to simulate a brittle object breaking when subjected to vibration, if the gravity exerted on the body 41 and by the user varies threefold, the processing unit 46 will determine that the object is subjected to vibration strong enough to break the object, and thus the processing unit 46 will control the performance device 61 to produce a color for functioning as a mark.

The other structures of the second embodiment are identical to that of the first embodiment and thus are not described in detail herein for the sake of brevity.

The above embodiments are provided to illustrate and disclose the implementation of the present invention rather than restrict the claims of the present invention. Other equivalent modifications derived from the claims of the present invention should fall within the scope of the present invention.

What is claimed is:

1. An electronic device for sensing and recording a dynamic state to enable a performance device to present a corresponding performance, the electronic device comprising:
a body;
a processing unit disposed in the body;
a sensing module disposed in the body and electrically connected to the processing unit such that, once the body enters a dynamic state, the sensing module will detect the dynamic state of the body and send a detected signal to the processing unit; and
a storage module disposed in the body and electrically connected to the processing unit,
wherein the electronic device is characterized in that:
the processing unit carries out consecutively the following actions:
a signal recording action for recording a signal detected by the sensing module and storing the detected signal in the storage module; and
a signal converting action for converting the detected signal stored in the storage module into an output data, wherein the output data relates to a dynamic trace of the body,
wherein the processing unit sends the output data to a performance device, and an object performs the same dynamic trace as the body does according to the output data by means of the performance device.

2. The electronic device of claim 1, wherein the sensing module comprises at least a trace sensor.

3. The electronic device of claim 2, wherein the at least a trace sensor is one of a proximity sensor, acceleration sensor, gyroscope, G sensor, and geomagnetic sensor, or, alternatively, the at least a trace sensor is one of a plurality of proximity sensors, acceleration sensors, gyroscopes, G sensors, and geomagnetic sensors, or a combination thereof.

4. The electronic device of claim 1, wherein the performance device is a movable platform capable of moving and moving to and fro in at least one of four directions, namely the directions of x-axis, y-axis, z-axis, and φ-axis (rotation axis), wherein the object is removably fixed to the movable platform.

5. The electronic device of claim 4, wherein the movable platform has a clamp for clamping the object.

6. The electronic device of claim 4, wherein the processing unit is connected to the performance device by wired connection or wireless connection.

7. An electronic device for sensing and recording a dynamic state to enable a performance device to present a corresponding performance, the electronic device comprising:
a body;
a processing unit disposed in the body;
a sensing module disposed in the body and electrically connected to the processing unit such that, once the body enters a dynamic state, the sensing module will detect the dynamic state of the body and send a detected signal to the processing unit; and
a storage module disposed in the body and electrically connected to the processing unit,
wherein the electronic device is characterized in that:
the electronic device further comprises a performance device electrically connected to the processing unit;
the processing unit carries out a signal recording action for recording a signal detected by the sensing module and storing the detected signal in the storage module;
the processing unit determines whether the signal stored in the storage module meets a threshold criterion and controls the performance device to carry out a performance action when the determination is affirmative.

8. The electronic device of claim 7, wherein the performance device is one of a loudspeaker, light source, vibration source, and marker, or a combination thereof, wherein the performance action involves, correspondingly, making a sound, emitting light, generating vibration, or producing a mark.

9. The electronic device of claim 7, wherein the signal stored in the storage module comprises at least one of trace, extent of variation in gravity, direction, and rotation-related data, wherein the threshold criterion is one of a trace length, extent of variation in gravity, number of direction changes, and whether a rotation angle is larger or smaller than a threshold value.
